(19) United States
(12) Patent Application Publication
(10) Pub. No.: US 2023/0347295 A1
(43) Pub. Date: Nov. 2, 2023

(54) METHOD OF MANUFACTURING PVDF COMPOSITE SEPARATION MEMBRANE AND PVDF COMPOSITE SEPARATION MEMBRANE MANUFACTURED USING THE SAME

(71) Applicant: ARUN CO., LTD., Incheon (KR)

(72) Inventors: Soon Bong OH, Incheon (KR); Jun Won OH, Incheon (KR)

(21) Appl. No.: 17/637,169

(22) PCT Filed: Nov. 18, 2021
(86) PCT No.: PCT/KR2021/016947

§ 371 Date: Feb. 22, 2022

(30) Foreign Application Priority Data
Oct. 19, 2021 (KR) 10-2021-0139001

(51) Int. Cl. B01D 67/00; B01D 69/14; B01D 71/34; B01D 71/02; B01D 69/10; B01D 69/02; B01D 69/12

(52) U.S. Cl. CPC B01D 67/00793; B01D 69/148; B01D 71/34; B01D 71/0211; B01D 71/0212; B01D 71/024; B01D 69/10; B01D 69/02; B01D 69/1213; B01D 2325/02834; B01D 2325/24; B01D 2325/20; B01D 2323/081; B01D 2323/082; B01D 2323/18; B01D 2323/2185; B01D 2323/2187; B01D 2323/21819; B01D 2323/56

(57) ABSTRACT

A method of manufacturing a PVDF composite separation membrane according to an embodiment of the present disclosure has advantages in that it is possible to control the size of pores in various ways based on the nonsolvent-induced phase transition process and calcination process, and manufacture a porous high-strength PVDF composite separation membrane having high water permeability, and it is possible to manufacture a PVDF composite separation membrane which may exhibit durability that does not damage the membrane even under high pressure, while having heat resistance applicable even at a high temperature of 150° C., and excellent chemical resistance to acids and alkalis, and suppress heavy metal adsorption and biofouling phenomenon, and may allow an organic material to be decomposed by ultrasonic waves or UV photocatalysts. In addition, the PVDF composite separation membrane has excellent mechanical, thermal and chemical resistance properties, suppresses the biofouling phenomenon, and exhibits high ultrasonic reactivity.

### CROSS REFERENCE TO RELATED APPLICATIONS AND CLAIM OF PRIORITY

This application claims benefit under 35 U.S.C. 119(e), 120, 121, or 365(c), and is a National Stage entry from International Application No. PCT/KR 2021/016947, filed Nov. 18, 2021, which claims priority to the benefit of Korean Patent Application No. 10-2021-0139001 filed in the Korean Intellectual Property Office on Oct. 19, 2021, the entire contents of which are incorporated herein by reference.

### BACKGROUND

### 1. Technical Field

The present invention relates to a method of manufacturing a polyvinylidene fluoride (PVDF) composite separation membrane and a PVDF composite separation membrane manufactured using the same.

### 2. Background Art

Filtration processes have been widely used in industrial fields such as a sterile water, high-purity water or beverage production field, air purification field and the like. Recently, the application range of the filtration is expanding into fields such as secondary or tertiary treatment in sewage treatment plants for treating domestic wastewater and industrial wastewater, etc., water treatment of high turbidity source for solid-liquid separation in septic tanks and the like.

A water treatment membrane used in the filtration process is intended to adsorb pollutants on the membrane surface while filtering the contaminated raw water, thereby causing membrane surface contamination called membrane fouling. Such contamination of the membrane surface causes an increase in the water permeation pressure acting during filtration and a gradual reduction in an amount of produced water, thereby resulting in a problem in that the filtration function of the water treatment membrane is ultimately decreased.

Meanwhile, as a material of the separation membrane, polysulfone, polyethersulfone, PVDF polymer material, and the like, which have excellent mechanical, thermal and chemical resistance properties, are mainly used.

As an example, Korean Patent Laid-Open Publication No. 2002-0069602 relates to a lithium secondary polymer battery. The lithium secondary polymer battery disclosed in this document has a structure including: an anode composed of a polymer binder selected from a carbon material capable of intercalating and deintercalating lithium ions, and P (VDF-HFP) having PVDF or HFP in a content of 2 to 25% by weight (‘wt. %); a cathode composed of a polymer binder selected from a lithium composite oxide, a conductive agent, and P(VDF-HFP) having PVDF or HFP in a content of 2 to 25 wt. %; and a polyelectrolyte composed of a polymer membrane having a porous structure formed by applying a slurry, in which a moisture absorbent and a plasticizer are dissolved in a polymer matrix selected from P(VDF-HFP) having PVDF or HFP in an content of 2 to 25 wt. %, to a base film, and then extracting the plasticizer with a solvent, and an electrolyte composed of lithium salt/aprotic solvent.

In addition, Korean Patent Laid-Open No. 2009-0133100 relates to a method of hydrophilizing a water treatment membrane and a water treatment membrane. The method of hydrophilizing a water treatment membrane disclosed in this document includes the step of treating a fluorine-based water treatment membrane using a hydrophilizing agent containing at least one selected from the group consisting of acids, bases and polyhydric alcohols.

However, in the case of the prior art documents, there is still a problem in that the biofouling phenomenon cannot be suppressed. In particular, when using ultrasonic waves for removing foreign matters accumulated on the separation membrane, there are some problems of causing damage to the membrane.

Therefore, development of a polymer separation membrane that may suppress the biofouling phenomenon and prevent the membrane from being damaged due to the ultrasonic waves during washing is required.

### SUMMARY

An object of the present invention is to provide a method of manufacturing a PVDF composite separation membrane which may manufacture a PVDF composite separation membrane having excellent mechanical, thermal and chemical resistance properties.

In addition, another object of the present invention is to provide a method of manufacturing a PVDF composite separation membrane which may suppress the biofouling phenomenon.

Further, another object of the present invention is to provide a method of manufacturing a PVDF composite separation membrane which suppresses damage caused by ultrasonic waves while exhibiting high ultrasonic reactivity.

Furthermore, another object of the present invention is to provide a PVDF composite separation membrane which has excellent mechanical, thermal and chemical resistance properties, and suppresses fouling phenomenon caused by particles, while exhibiting high ultrasonic reactivity.

To achieve the above objects, according to an aspect of the present invention, there is provided a method of manufacturing a PVDF composite separation membrane, including: mixing 0.1 to 10 parts by weight of at least one carbon structure selected from the group consisting of oxidized graphene including a carboxyl group or a hydroxyl group, reduced graphene and carbon nanotubes, with 0.1 to 12 parts by weight of titanium oxide in 65 to 95 parts by weight of a solvent, and dispersing the mixture with ultrasonic waves to obtain a first solution; mixing 1 to 18 parts by weight of a first pore regulator including polyethylene glycol (PEG) having a molecular weight of 190 to 610, and 1 to 22 parts by weight of a second pore regulator including polyvinylpyrrolidone (PVP) having a weight average molecular weight of 8,000 to 900,000 with the first solution, and stirring the mixture at a temperature of 70 to 90° C. to obtain a second solution; mixing 21 to 38 parts by weight of a polyvinylidene fluoride (PVDF) polymer with the second solution and stirring the mixture at a temperature of 70 to 90° C. to obtain a third solution; forming a film from the third solution on a surface of a mesh having a pore size of 25 to 400 μm opposite to one surface provided with a release paper, followed by casting so as to have a thickness of 20 to 600 μm to obtain a primary film forming composite separation membrane; causing a primary phase transition of the primary film forming composite separation membrane in alcohol; causing a secondary phase transition of the primary phase-transited primary film forming composite separation membrane in distilled water; removing the release paper, and then washing the primary film forming composite separation membrane; drying the washed primary film forming composite separation membrane at a temperature of 80 to 120° C.; calcining the dried primary film forming composite separation membrane in an atmospheric furnace at a temperature of 180 to 220° C. to melt and bond the PVDF of the primary film forming composite separation membrane with the mesh, followed by cooling; forming a film from the third solution on the one surface of the mesh from which the release paper of the cooled primary film forming composite separation membrane is removed, followed by casting so as to have a thickness of 20 to 600 μm to obtain a secondary film forming composite separation membrane; causing a primary phase transition of the secondary film forming composite separation membrane in alcohol; causing a secondary phase transition of the primary phase-transited secondary film forming composite separation membrane in distilled water; washing the secondary film forming composite separation membrane; drying the washed secondary film forming composite separation membrane at a temperature of 80 to 120° C.; and calcining the dried secondary film forming composite separation membrane in an atmospheric furnace at a temperature of 230 to 290° C. to melt and bond the PVDF of the secondary film forming composite separation membrane with the mesh, followed by cooling.

According to another aspect of the present invention, there is provided a double-sided PVDF composite separation membrane manufactured by the above-described method of manufacturing a PVDF composite separation membrane.

The method of manufacturing a PVDF composite separation membrane has advantages in that it is possible to control the size of pores in various ways based on the nonsolvent-induced phase transition process and calcination process, and manufacture a porous high-strength PVDF composite separation membrane having high water permeability.

In addition, the method of manufacturing a PVDF composite separation membrane has advantages in that it is possible to manufacture a PVDF composite separation membrane which may exhibit durability that does not damage the membrane even under high pressure, while having heat resistance applicable even at a high temperature of 150° C., and excellent chemical resistance to acids and alkalis, and suppress heavy metal adsorption and biofouling phenomenon, and may allow an organic material to be decomposed by ultrasonic waves or UV photocatalysts.

Further, the method of manufacturing a PVDF composite separation membrane has advantages in that it is possible to manufacture a PVDF composite separation membrane which may exhibit reactivity sensitive to high pressure and ultrasonic waves of 20 KHz or higher, as well as prevent phenomena in which the separation membrane is separated from the mesh due to ultrasonic waves, titanium and graphene are detached from the polymer, or the membrane is damaged.

In addition, there are advantages in that the PVDF composite separation membrane according to the present invention has excellent mechanical, thermal and chemical resistance properties, suppresses the biofouling phenomenon, and exhibits high ultrasonic reactivity.

### DETAILED DESCRIPTION

Hereinafter, the present invention will be described in more detail.

In the present invention, when a member is located “on” another member, it includes not only a case in which the member is in direct contact with another member but also a case in which another member is interposed between the two members.

In the present invention, when a portion “includes” a component, this means that the portion may further include other components, rather than excluding other components, unless the context particularly describes otherwise.

<Method of Manufacturing PVDF Composite Separation Membrane>

An aspect of the present invention relates to a method of manufacturing a PVDF composite separation membrane, which includes: mixing 0.1 to 10 parts by weight (‘wt. parts’) of at least one carbon structure selected from the group consisting of oxidized graphene including a carboxyl group or a hydroxyl group, reduced graphene and carbon nanotubes, with 0.1 to 12 wt. parts of titanium oxide in 65 to 95 wt. parts of a solvent, and dispersing the mixture with ultrasonic waves to obtain a first solution; mixing 1 to 18 wt. parts of a first pore regulator including polyethylene glycol (PEG) having a molecular weight of 190 to 610, and 1 to 22 wt. parts of a second pore regulator including polyvinylpyrrolidone (PVP) having a weight average molecular weight of 8,000 to 900,000 with the first solution, and stirring the mixture at a temperature of 70 to 90° C. to obtain a second solution; mixing 21 to 38 wt. parts of a polyvinylidene fluoride (PVDF) polymer with the second solution and stirring the mixture at a temperature of 70 to 90° C. to obtain a third solution; forming a film from the third solution on a surface of a mesh having a pore size of 25 to 400 μm opposite to one surface provided with a release paper, followed by casting so as to have a thickness of 20 to 600 μm to obtain a primary film forming composite separation membrane; causing a primary phase transition of the primary film forming composite separation membrane in alcohol; causing a secondary phase transition of the primary phase-transited primary film forming composite separation membrane in distilled water; removing the release paper, and then washing the primary film forming composite separation membrane; drying the washed primary film forming composite separation membrane at a temperature of 80 to 120° C.; calcining the dried primary film forming composite separation membrane in an atmospheric furnace at a temperature of 180 to 220° C. to melt and bond the PVDF of the primary film forming composite separation membrane with the mesh, followed by cooling; forming a film from the third solution on the one surface of the mesh from which the release paper of the cooled primary film forming composite separation membrane is removed, followed by casting so as to have a thickness of 20 to 600 μm to obtain a secondary film forming composite separation membrane; causing a primary phase transition of the secondary film forming composite separation membrane in alcohol; causing a secondary phase transition of the primary phase-transited secondary film forming composite separation membrane in distilled water; washing the secondary film forming composite separation membrane; drying the washed secondary film forming composite separation membrane at a temperature of 80 to 120° C.; and calcining the dried secondary film forming composite separation membrane in an atmospheric furnace at a temperature of 230 to 290° C. to melt and bond the PVDF of the secondary film forming composite separation membrane with the mesh, followed by cooling.

In accordance with the method of manufacturing a PVDF composite separation membrane, it is possible to control the size of pores in various ways based on the nonsolvent-induced phase transition process and calcination process, and manufacture a porous high-strength PVDF composite separation membrane having high water permeability.

Step of Obtaining First Solution

The method of manufacturing a PVDF composite separation membrane according to the present invention includes the step of mixing at least one carbon structure selected from the group consisting of oxidized graphene including a carboxyl group or a hydroxyl group, reduced graphene and carbon nanotubes, with titanium oxide in a solvent, and dispersing the mixture with ultrasonic waves to obtain a first solution.

The oxidized or reduced graphene may be used by directly oxidizing or reducing graphene, or if there is a commercially available form, the commercially available product may be used. When the oxidized or reduced graphene is included in the PVDF composite separation membrane, there are effects of inhibiting and killing microorganisms on the surface or pores of a filter and removing heavy metals, thus being preferable.

Specifically, the method of manufacturing a PVDF composite separation membrane according to the present invention may include the step of mixing at least one carbon structure selected from the group consisting of oxidized graphene which may include a carboxyl group and a hydroxyl group, reduced graphene oxide (rGO) obtained by reducing it again and carbon nanotubes, with titanium oxide in the solvent, and dispersing the mixture with ultrasonic waves to obtain a first solution.

The carbon nanotubes may be used without limitation as long as they are commonly used in the art, and preferably, carbon nanotubes having an average particle diameter of 1 to 100 nm and an average length of 1 to 100 μm are used, but it is not limited thereto. However, when the average particle diameter satisfies the above range, it is possible to suppress the problem that the carbon nanotubes are broken, and suppress the problem of reducing the economic advantages compared to the stretching method. Therefore, it is preferable to use the carbon nanotubes having an average particle diameter that satisfies the above range. In addition, when the carbon nanotubes have an average length that satisfies the above range, pores may be easily formed, and the problem that the carbon nanotubes are broken may be suppressed. Therefore, it is preferable to use the carbon nanotubes having an average length that satisfies the above range.

As the carbon nanotubes, surface-functionalized carbon nanotubes may be used, and a method of functionalizing the surface of the carbon nanotubes is not limited in the present invention. For example, carbon nanotubes whose surface is functionalized by using a surfactant, acid treatment, or the like may be used.

The carbon nanotubes may have various structures including types of single-walled, multi-walled, and bundled carbon nanotubes, and the type is not limited, but the type of multi-walled carbon nanotubes is more preferably used. In addition, the carbon nanotubes are divided into zigzag, armchair, and chiral types according to the rolled angle, which are related to electrochemical properties such as metallic properties and semiconducting properties, and thus they are not limited to any one type.

Titanium oxide (titanium dioxide, TiO₂) may exist in a crystalline form, such as anatase, rutile, brookite and the like. Among them, anatase and rutile phase TiO₂ with high photocatalytic activity are applied. Anatase and rutile phase TiO₂ have bandgap energies of 3.2 eV and 3.0 eV, respectively, and photocatalytic activity occurs in an ultraviolet region with a wavelength of 400 nm or less. When the TiO₂ surface is irradiated with a light energy greater than the bandgap energy, electrons in the valence band are transited to the conduction band, thereby creating pairs of electrons (e⁻) and holes (h⁺). The holes generated in the valence band contribute to an oxidation reaction and react with water molecules adsorbed on the surface to generate hydroxyl radicals (·OH) or to oxidize an organic material through a direct reaction. The electrons generated in the conduction band cause a reduction reaction of oxygen molecules to form superoxide ions (·O₂⁻), and generate hydroxyl radicals through several additional reactions. The organic material may be decomposed into carbon dioxide and water by the hydroxyl radicals generated by the holes and electrons.

The method of manufacturing a PVDF composite separation membrane according to the present invention uses at least one carbon structure selected from the group consisting of oxidized graphene or reduced graphene and carbon nanotubes, and the titanium oxide. Therefore, it is possible to obtain a PVDF composite separation membrane that may inhibit the growth of microorganisms, kill the microorganisms, and have excellent performance in terms of adsorbing harmful heavy metals.

The carbon structure may be included in an amount of 0.1 to 10 wt. parts, preferably 0.1 to 8 wt. parts, and more preferably 0.1 to 5 wt. parts, respectively, based on 65 to 95 wt. parts of the solvent included in the first solution.

The titanium oxide may be included in an amount of 0.1 to 12 wt. parts, preferably 0.1 to 10 wt. parts, and more preferably 0.1 to 8 wt. parts, based on 65 to 95 wt. parts of the solvent included in the first solution.

When the carbon structure and titanium oxide are respectively included within the above range, it is possible to manufacture a composite separation membrane that suppresses the biofouling phenomenon and reacts to a photocatalyst, while having excellent mechanical strength. Therefore, these components are preferably included within the above range.

The solvent is not limited as long as it can disperse the carbon structure, and for example, may include at least one selected from the group consisting of N-methyl-2-pyrrolidone (NMP), dichlorobenzene, chloroform, dimethylformamide (DMF), N,N′-dimethylacetamide (DMAC), diethylene glycol (DEG), and dimethyl sulfonside (DMSO).

Ultrasonic waves for dispersion may be performed at a temperature of 50° C. or lower, and preferably at a temperature of 40 to 50° C. for 30 minutes to 8 hours, specifically, 1 hour to 7 hours, and more specifically, 3 hours to 6 hours, but it is not limited thereto. However, when the ultrasonic dispersion is performed within the above range, a first solution having excellent dispersibility of the oxidized or reduced graphene, the carbon nanotube, and the titanium oxide may be obtained, thus being preferable.

Step of Obtaining Second Solution

The method of manufacturing a PVDF composite separation membrane according to the present invention includes the step of mixing a first pore regulator and a second pore regulator with the first solution, and stirring the mixture to obtain a second solution.

Preferably, the first solution may include a first pore regulator including polyethylene glycol (PEG) having a molecular weight of 190 to 610 and a second pore regulator including polyvinylpyrrolidone (PVP) having a weight average molecular weight of 8,000 to 900,000. In this case, there is an advantage in that it is possible to manufacture a PVDF composite separation membrane having uniform pores and high water permeability.

Specifically, the pore regulator may include the first pore regulator and the second pore regulator.

In particular, the first pore regulator may include PEG having a molecular weight of 190 to 610. For example, the PEG may include PEG 200, PEG 400, PEG 600 and the like.

Specifically, the second pore regulator may include PVP having a weight average molecular weight of 8,000 to 900,000, and the weight average molecular weight is preferably 10,000 to 500,000, more preferably 20,000 to 100,000, even more preferably 30,000 to 70,000, and most preferably 50,000. For example, the PVP may include PVP K17, PVP K30, PVP K90 and the like. When the weight average molecular weight exceeds 900,000, the pore regulator may be bonded to a polymer without being completely discharged during phase transition to increase a thickness of the separation membrane. When the weight average molecular weight is less than 8,000, a range of controlling the pores of the composite separation membrane may be limited.

Specifically, it is preferable that 1 to 18 wt. parts of the first pore regulator and 1 to 22 wt. parts of the second pore regulator are mixed with the first solution, and the mixture is stirred to obtain a second solution. The first solution may be included in an amount of 50 to 200 wt. parts.

When the first pore regulator and the second pore regulator are respectively included within the above range, the size of the pores of the PVDF composite separation membrane may be appropriately controlled. In this case, it is possible to manufacture a PVDF composite separation membrane capable of suppressing the biofouling phenomenon, while having excellent mechanical strength. Therefore, these components are preferably included within the above range.

The stirring of the mixture to obtain the second solution is performed at a temperature of 70 to 90° C. for 1 hour to 4 hours, preferably 2 hours to 4 hours, and more preferably 3 hours to 4 hours, but it is not limited thereto.

Step of Obtaining Third Solution

The method of manufacturing a PVDF composite separation membrane according to the present invention includes the step of mixing a polyvinylidene fluoride (PVDF) polymer with the second solution, and stirring the mixture to obtain a third solution.

Preferably, the PVDF polymer may be included in an amount of 21 to 38 wt. parts, and more preferably 23 to 38 wt. parts based on 50 to 200 wt. parts of the second solution. In this case, it is possible to obtain a PVDF composite separation membrane having excellent chemical resistance properties and excellent durability, thus being preferable.

The PVDF polymer is a polymer having excellent mechanical strength, thermal stability, chemical resistance and the like. Therefore, the composite separation membrane according to the present invention manufactured using the same also has advantages of excellent mechanical strength, thermal stability, chemical resistance and the like.

The PVDF composite separation membrane according to the present invention may be a porous separation membrane. The porous separation membrane may have pores that communicate from an inside to an outside, or pores that exist only the inside. In addition, the porous separation membrane may be used as a meaning that can be commonly understood by persons who have a common knowledge in the technical field to which the present invention pertains.

In the step of obtaining the third solution, it is preferable that the PVDF is mixed with the second solution, and the mixture is stirred at a temperature of 70 to 90° C.

The step of obtaining the third solution may be performed at a temperature of 70 to 90° C., preferably at a temperature of 80 to 90° C., and more preferably at a temperature of 80 to 85° C. In this case, in order to shorten an execution time while securing excellent solubility of the PVDF without changing physical properties, increase solubility and remove air bubbles, it is preferable to simultaneously perform the stirring of the mixture.

The step of obtaining the third solution may be performed for 3 to 8 hours, preferably 3 to 6 hours, and more preferably 3 to 5 hours, but it is not limited thereto.

In one embodiment of the present invention, the PVDF may have a weight average molecular weight of 570,000 to 7000,000, but it is not limited thereto. However, within the above range, it is possible to obtain a PVDF composite separation membrane capable of suppressing membrane erosion in high-output ultrasonic waves, and suppressing membrane breakage even when applying high pressure thereto while having better mechanical strength, thus being preferable.

In the present invention, since the first solution, the second solution, and the third solution are obtained step by step, the graphene and titanium oxide of the first solution, the pore regulators of the second solution, and the PVDF of the third solution may be uniformly dissolved step by step. Thus, there are advantages in that the PVDF composite separation membrane has uniform pores, water permeability, performance and the like.

Step of Obtaining Primary Film Forming Composite Separation Membrane

The method of manufacturing a PVDF composite separation membrane according to the present invention includes the step of forming a film by casting the third solution on a surface of a mesh having a pore size of 25 to 400 μm opposite to one surface provided with a release paper (the surface opposite to one surface will be referred to as the other surface), to obtain a primary film forming composite separation membrane on which a polymer layer is formed.

Specifically, the step of forming a film and then casting so as to have a thickness of 20 to 600 μm to obtain a primary film forming composite separation membrane having the polymer layer formed thereon may be a step of forming a film from the third solution, and then forming a film on the other surface of the mesh so as to have a thickness of 20 to 600 μm.

Since the method of manufacturing a PVDF composite separation membrane according to the present invention uses the mesh and the calcination method, there is an advantage in that membrane damage due to ultrasonic waves does not occur, compared to a conventional PVDF polymer membrane manufactured by phase separation. Specifically, when removing foreign matters accumulated on the PVDF composite separation membrane using ultrasonic waves, there are advantages in that the eroded foreign matters may be easily removed by the ultrasonic waves due to excellent ultrasonic reactivity, as well as a phenomenon in which the PVDF composite separation membrane is damaged does not occur.

The material of the mesh is not limited as long as it is not chemically affected or not affect in using the PVDF composite separation membrane according to the present invention while not inhibiting the object of the present invention. For example, the mesh may use a metal mesh or a non-metal mesh, and the metal mesh and the non-metal mesh may be a corrosion-resistant material.

Examples of the metal mesh may specifically include stainless steel, and a Ni—Cr alloy, and examples of the non-metal mesh may specifically include a carbon fiber mesh, but they are also not limited thereto.

In short, as the mesh, any type of mesh may be used without limitation thereof as long as it can withstand the calcination temperature, which is the melting point of the polymer, and the material of the mesh may be selected and used depending on the application of the composite separation membrane, that is, it is intended to filter any material. When selecting a material having a high ultrasonic transmission rate as the material of the mesh, the effect of suppressing the fouling phenomenon caused by particles is maximized, thus being preferable.

As the stainless steel, well-known stainless steels may be used, without particular limitation thereof. Among them, an alloy containing 8% by mass (‘mass %’) or more of Ni is preferable, and austenitic stainless steel containing 8 mass % or more of Ni is more preferable. Examples of the austenitic stainless steel may include, for example, steel use stainless (SUS) 304 (having a Ni content of 8 mass %, and a Cr content of 18 mass %), SUS304L (having a Ni content of 9 mass %, and a Cr content of 18 mass %), SUS316 (having a Ni content of 10 mass %, and a Cr content of 16 mass %), SUS316L (having a Ni content of 12 mass %, and a Cr content of 16 mass %) and the like.

As the Ni—Cr alloy, well-known Ni—Cr alloys may be used, without particular limitation thereof. Among them, a Ni—Cr alloy having a Ni content of 40 to 75 mass % and a Cr content of 1 to 30 mass % is preferably used.

Examples of the Ni—Cr alloy may include Hastelloy (trade name, hereinafter the same), Monel (trade name, hereinafter the same), Inconel (trade name, hereinafter the same) and the like.

In addition, the Ni—Cr alloy may further contain B, Si, W, Mo, Cu, Co, and the like, other than the above-described alloys as necessary.

As the carbon fiber mesh, carbon fibers which have undergone stabilizing or insolubilizing treatment at 200 to 300° C. in air, and then have been subjected to heat treatment at a temperature of 1200° C. or higher under a non-oxidizing atmosphere to remove atoms other than carbon may be used, but it is not limited thereto.

The mesh may have a pore size of 25 to 400 μm, preferably 25 to 300 μm, and more preferably 25 to 400 μm. In this case, a PVDF composite separation membrane having excellent mechanical strength and excellent water permeability may be obtained, thus being preferable.

The mesh may have a thickness of 40 to 600 μm, preferably 45 to 400 μm, and more preferably 45 to 300 μm. In this case, there is an advantage that the PVDF composite separation membrane to be manufactured may have an appropriate thickness while having excellent durability, thereby being utilized in various places.

However, it is preferable to select the thickness of the mesh smaller than the desired thickness after forming the film in terms of durability. Specifically, when the thickness of the mesh is smaller than the desired thickness after forming the film, the mesh, which is a support for supporting the composite separation membrane, is not in a lower portion through which water permeates, but is in a form that supports all sides, such that there is a desirable advantage in terms of the water permeability as well as the durability.

In addition, it is preferable that the mesh has a porosity larger than the porosity of the primary film forming composite separation membrane. The pore size or porosity of the primary film forming composite separation membrane formed on one surface may be different from the pore size or porosity of the secondary film forming composite separation membrane formed on the other surface, which will be described below. Preferably, the primary film forming composite separation membrane and the secondary film forming composite separation membrane may have a pore size of 5 to 20 μm, respectively.

In order to prepare a primary film forming composite separation membrane in which a polymer layer is primarily formed on only one surface, the mesh is provided with a release paper on one surface. The material of the release paper may be glass, ceramic, plastic, silicon wafer, nonwoven fabric, fabric, paper, and the like, but it is not limited thereto. Specifically, the material of the release paper may be paper. The release paper is provided on one surface of the mesh, thereby serving to facilitate that the polymer layer is formed only on one surface of the mesh. The release paper may be attached to one surface of the mesh. Specifically, a polymer layer is formed by attaching the release paper to one surface of the mesh, casting the third solution on an upper portion of the mesh, and causing primary and secondary phase transitions thereof, followed by solidifying the same, and then the release paper is peeled-off, such that it is possible to manufacture a primary film forming composite separation membrane having the polymer layer formed on one surface thereof.

The casting is not limited in term of the method, and methods commonly performed in the art may be used. For example, a casting knife may be used to control a casting thickness, but it is not limited thereto.

The casting may be performed so that the polymer layer after forming the film has a thickness of 20 to 600 μm, preferably 20 to 500 μm, and more preferably 20 to 400 μm. In this case, the PVDF composite separation membrane is excellent in terms of water permeability and durability while having a thin thickness, thus being preferable. In addition, since the solvent-nonsolvent substitution process to be described below is easily performed, it is preferable that the polymer layer has a thickness that satisfies the above range.

Step of Primary Phase Transition

The method of manufacturing a PVDF composite separation membrane according to the present invention includes the step of causing a primary phase transition of the primary film forming composite separation membrane in alcohol.

In short, in the present invention, a PVDF composite separation membrane, specifically, a porous PVDF composite separation membrane is manufactured using a nonsolvent-induced phase transition process. Thereby, the PVDF composite separation membrane according to the present invention has advantages in that the biofouling phenomenon is suppressed while exhibiting high water permeability and ultrasonic reactivity, and damage due to ultrasonic waves is suppressed.

When the mesh on which the third solution is cast is immersed in a coagulation bath filled with alcohol as the nonsolvent, the solvent in the third solution is dissolved into the alcohol as the nonsolvent, whereas the polymer is not dissolved into the nonsolvent. As a result, a polymer phase and pores are formed.

In another embodiment of the present invention, the primary phase transition may be performed for 5 minutes to 80 minutes, and preferably 5 minutes to 60 minutes. In this case, it is possible to manufacture a PVDF composite separation membrane having an appropriate pore size while minimizing the primary phase transition time. Therefore, it is preferable that the phase transition is performed within the above range. When the primary phase transition time is less than the above range, the phase transition may not be completely performed because the phase transition time is slightly short. Therefore, it is preferable that the phase transition is performed for a time within the above range.

The alcohol may include methanol or ethanol, but it is not limited thereto. Specifically, the alcohol may be methanol or ethanol. For example, 90 to 99.9% of alcohol may be used, and commercially available alcohol may be used at the above concentration, as well as the alcohol may be diluted with distilled water to a concentration in the above range and used. When using the alcohol by dilution, pores may be contracted due to an exothermic reaction.

Step of Secondary Phase Transition

The method of manufacturing a PVDF composite separation membrane according to the present invention includes the step of causing a secondary phase transition of the primary phase-transited primary film forming separation membrane in distilled water.

In another embodiment of the present invention, the secondary phase transition may be performed for 10 minutes to 1 hour, preferably 10 minutes to 50 minutes, and more preferably 10 minutes to 30 minutes. In this case, it is possible to have a sufficient phase transition time, and form pores having a size of 0.05 to 20 μm, thus being preferable. In addition, the polymer film to be prepared, that is, the PVDF film has excellent mechanical properties and chemical resistance, thus being preferable.

In the present invention, by performing the primary phase transition in alcohol and the secondary phase transition in distilled water to be described below, there is an effect that the PVDF composite separation membrane, which is manufactured through the additionally performed removal of the solvent and coagulation of the composite separation membrane, has excellent durability.

The secondary phase transition may be performed, for example, by immersing the primary phase-transited primary film forming composite separation membrane in a coagulation bath containing the distilled water, but it is not limited thereto, and may be performed by methods commonly used in the art.

Steps of Removing the Release Paper and Washing the Composite Separation Membrane

The method of manufacturing a PVDF composite separation membrane according to the present invention includes the step of removing the release paper, and then washing the primary film forming composite separation membrane. The release paper may be easily removed by peeling-off from one surface of the mesh of the primary film forming composite separation membrane that has been solidified after undergoing the primary phase transition and the secondary phase transition processes. As the release paper is peeled-off from the composite separation membrane, the primary film forming composite separation membrane according to the present invention includes the mesh and the polymer layer provided on the mesh.

The washing is a process for removing residual impurities, and is capable of removing a solvent which may remain on the composite separation membrane due to the primary phase transition and secondary phase transition. The washing may be performed using the distilled water or the alcohol, and may be performed twice or more times as necessary, but it is not limited thereto.

In addition, the washing method may be performed using immersion, etc., but it is not limited thereto, and may be performed using methods commonly used in the art.

Drying Step

The method of manufacturing a PVDF composite separation membrane according to the present invention includes the step of drying the washed primary film forming composite separation membrane at a temperature of 80 to 120° C.

Specifically, the primary film forming composite separation membrane, on which the washing step is completed, undergoes the step of drying in an atmospheric furnace or in an oven at a temperature of 80 to 120° C. to remove the solvent such as water. In this case, the drying may be performed under air atmosphere, and the drying time may be, for example, 30 minutes to 3 hours, but it is not limited thereto.

For example, the drying may be performed at a temperature of 80° C. to 120° C., preferably 80° C. to 110° C., and more preferably 80° C. to 100° C.

The drying may be performed for an appropriate time, and it is not limited in the present invention.

Steps of Calcining and Cooling the Primary Film Forming Composite Separation Membrane

The method of manufacturing a PVDF composite separation membrane according to the present invention includes the step of calcining the dried primary film forming composite separation membrane in an atmospheric furnace at a temperature of 180 to 220° C., followed by cooling.

Specifically, the calcination of the primary film forming composite separation membrane is a method of calcining the same at a temperature of melting point or higher of the polymer to melt and bond the polymer and the polymer, or the polymer and the mesh. Therefore, any temperature may be applied to the calcination as long as it is the thermal decomposition temperature or lower of the polymer, specifically, PVDF. However, in the case of a high temperature exceeding the above range, the density of the tissue between the polymers is increased to enhance the strength, but the pores may be enlarged to affect the melt bonding of the secondary film forming composite separation membrane which is subsequently cast on the other surface of the mesh, and the polymer may be thermally decomposed such that the function of the separation membrane may be lost. Therefore, it is preferable to perform the calcination at a temperature of 180° C. to 220° C., which is near the melting temperature of the polymer, specifically, PVDF.

More specifically, a third solution is applied to the surface of the mesh, for example, the metal mesh wire and the surface thereof when using a metal mesh, and the calcination at a temperature above the melting point of the metal mesh, such that the polymer and the polymer in the third solution are melt bonded, and the metal mesh and the polymer surrounding the same are melt bonded.

The pores of the primary film forming composite separation membrane formed through the phase transition step are not collapsed even at the melting temperature of the polymer by the mesh layer during calcination. In addition, the polymer layer is maintained without flowing down, and is melted through the calcination step, such that the thickness of the primary film forming composite separation membrane is reduced to enhance the density, but the pores may be enlarged than before the calcination.

In addition, when the polymer has a slightly low molecular weight, the pore size may be slightly enlarged. However, due to the mesh, a phenomenon, in which the pores are collapsed without being enlarged to the size or more of the mesh pores, is suppressed, and the thickness after forming the film, the thickness after phase transition, the thickness after drying, and the thickness after calcination are uniformly reduced, such that the density is enhanced.

For example, the primary film forming composite separation membrane may be calcined in an atmospheric furnace at a temperature of 180 to 220° C.

The calcination time may be maintained for 5 to 30 minutes, preferably 10 to 20 minutes, and more preferably 20 minutes after reaching the desired maximum temperature.

The cooling may be performed, for example, at a temperature of 150° C. or lower, and preferably 100° C. or lower, but it is not limited thereto. Specifically, the cooling temperature is a temperature at which the polymer of the composite separation membrane is solidified again, and is not limited as long as it is a temperature that does not cause a problem in handling. When undergoing the cooling process, there is an advantage in that the mechanical strength of the PVDF composite separation membrane is further increased.

Step of Obtaining Secondary Film Forming Composite Separation Membrane

In the method of manufacturing a PVDF composite separation membrane according to the present invention includes the step of forming a film from the third solution on one surface of the mesh from which the release paper is removed, followed by casting so as to have a thickness of 20 to 600 μm to obtain a secondary film forming composite separation membrane.

Specifically, a polymer layer having pores formed on one surface of the mesh is calcined to form a primary film forming composite separation membrane, and then the polymer layer including micropores is calcined on the mesh surface from which the release paper is removed to form a secondary film forming composite separation membrane having the polymer layers formed on both sides of the mesh. Thereby, it is possible to manufacture a separation membrane which has smooth fluidity of fluid and particles, as well as excellent pressure resistance, and is strong against ultrasonic waves.

Specifically, the step of forming a film and then casting so as to have a thickness of 20 to 600 μm to obtain a composite separation membrane is the step of forming a film from the third solution on the one surface of the mesh from which the release paper of the primary film forming composite separation membrane is removed so that the polymer layer has a thickness of 20 to 600 μm.

The method of the casting is not limited, and a method commonly performed in the art may be used. For example, a casting knife may be used to control the casting thickness, but it is not limited thereto.

The casting may be performed so as to have a film forming thickness of 20 to 600 μm, preferably 20 to 500 μm, and more preferably 20 to 400 μm. In this case, the PVDF composite separation membrane is excellent in terms of water permeability and durability while having a thin thickness, thus being preferable.

The method of manufacturing a PVDF composite separation membrane according to the present invention includes the step of causing a primary phase transition and a secondary phase transition of the secondary film forming composite separation membrane, and washing and drying the secondary film forming composite separation membrane.

The processes of the primary phase transition step, the secondary phase transition step, the washing step, and the drying step of the secondary film forming composite separation membrane are the same as those of the above-described primary film forming composite separation membrane, and therefore will be described in detail.

Steps of Calcining and Cooling the Secondary Film Forming Composite Separation Membrane

The method of manufacturing a PVDF composite separation membrane according to the present invention includes the step of calcining the dried secondary film forming composite separation membrane in an atmospheric furnace at a temperature of 230 to 290° C. to melt and bond the PVDF of the secondary film forming composite separation membrane with the mesh, followed by cooling.

Specifically, the calcination of the secondary film forming composite separation membrane may cause the polymer layer thereof to be melt bonded with the polymer layer of the primary film forming composite separation membrane formed on one surface of the mesh. For example, the polymer layers on both sides of the mesh may be melt bonded to surround the mesh, and form micropores of the polymer layer in the pores of the mesh.

More specifically, a third solution is applied to the surface of the mesh, for example, the metal mesh wire and the surface thereof when using a metal mesh, and the calcination at a temperature above the melting point of the metal mesh, such that the polymer and the polymer in the third solution are melt bonded. The polymer layers of the composite separation membrane may be formed on both sides of the mesh, and may be a form of surrounding the mesh by the polymer layers.

Preferably, the calcination is performed in an atmospheric furnace at a temperature of 230° C. to 290° C., which is a higher temperature than when calcining the primary film forming composite separation membrane.

The calcination time may be maintained for 5 to 30 minutes, preferably 10 to 20 minutes, and more preferably 20 minutes after reaching the desired maximum temperature.

Since the PVDF composite separation membrane according to the present invention undergoes the calcination process after forming the primary film and the calcination process after forming the secondary film, mechanical strength is maximized, as well as excellent durability is maintained. In particular, the conventional separation membrane has a problem, etc. in that, when removing foreign matters caught in the mesh using ultrasonic waves, the coated mesh cannot sufficiently withstand to be damaged due to the ultrasonic waves. On the other hand, the PVDF composite separation membrane according to the present invention has the polymer layers formed on both sides of the mesh through two calcination steps, such that the mesh and the polymer, as well as the polymer layers are melt bonded. Accordingly, there are advantages in that the composite separation membrane has excellent durability even under high pressure as well as ultrasonic waves. Specifically, the melt bonding may be melt crosslinking.

The cooling may be performed, for example, at a temperature of 150° C. or lower, and preferably 100° C. or lower, but it is not limited thereto. Specifically, the cooling temperature is a temperature at which the polymer of the composite separation membrane is solidified again, and is not limited as long as it is a temperature that does not cause a problem in handling. When undergoing the cooling process, there is an advantage in that the mechanical strength of the PVDF composite separation membrane is further increased.

The method of manufacturing a PVDF composite separation membrane according to the present invention is based on the nonsolvent-induced phase transition process and the calcination process, and may manufacture a PVDF composite separation membrane including multi pores having a size of 0.05 μm to 20 μm, in which the PVDF polymer, graphene and/or carbon nanotubes, and titanium oxide are complexly bonded with the mesh. Specifically, it is possible to manufacture a PVDF composite separation membrane having advantages in that the biofouling phenomenon may be suppressed while having a high ultrasonic reactivity, and when a large amount of foreign matters is accumulated on the PVDF composite separation membrane, the foreign matters may be easily removed, as well as film erosion due to the ultrasonic waves may be suppressed, while preventing the membrane from being damaged even when applying a high pressure thereto.

A flat membrane including a reverse osmosis (RO) membrane mainly has a form formed by applying a film forming solution to an upper portion of a polymer mesh layer such as polyamide. In this case, when applying heat thereto, the film forming solution is molten and penetrates into a lower mesh layer, which is not very good in terms of water permeability. In addition, a thermally induced phase separation (TIPS) method, in which PVDF is applied to a hollow fiber membrane and radiated by applying heat to the solution in order to increase a tensile strength, is a method of forming a dense layer and a macroporous layer. However, the method of applying a polymer to the upper portion of the lower support layer to prepare a membrane through the phase transition process has a problem in that the membrane is easily damaged by the foreign matters or an external impact, because it is not possible to maintain a high mechanical strength, and in the case of a flat membrane manufactured through a general type phase transition process, it is difficult to maintain the membrane by itself under high pressure due to a low tensile strength.

In addition, the hollow fiber membrane produced using PS, PES, PVDF, etc. has a circular structure form (having a diameter of 1 to 3 n, and a thickness to 200 to 300 μm) in which a center portion produced by the phase transition method is empty. Therefore, the hollow fiber membrane has a form in which the outermost portion is dense and macro pores are formed toward the inside, and is manufactured by a method of collecting thousands of strands into a cylinder and filtering, thereby having a disadvantage of being easily broken by the external impact.

In particular, when the conventional separation membrane that does not undergo the calcination is exposed to ultrasound waves for a long time, due to vibration and cavitation phenomena in the ultrasound waves, a phenomenon, in which the polymer membrane is decomposed, occurs, and the function as a separation membrane is lost. In addition, there is a problem in that, since a sound wave transmission power is weak due to physical properties of the polymer, it is not possible to effectively remove particulate matters embedded in the separation membrane when forming the pores due to the phase transition characteristics even if applying ultrasonic waves thereto.

However, the PVDF composite separation membrane according to the present invention has a form in which the mesh as a support for supporting the composite separation membrane is not located in the water permeable lower portion, but is located inside the polymer layer of the composite separation membrane to support all sides. Therefore, the inventive membrane has advantages in that there is no resistance in the water permeable portion having pores formed therein, and the melt bonded composite separation membrane is contracted, such that the water permeable portion has a thickness of 5 to 100 μm, and thereby the membrane has a high water permeability. In addition, the inventive membrane has advantages in that, since the polymers are melt bonded (melt cross-linked) with each other, the strength of the tissue is reinforced, such that breakage is suppressed even at high pressure, and the fouling phenomenon due to the particles is suppressed, and thereby enabling to continuously use. In particular, the PVDF composite separation membrane according to the present invention has excellent durability including tensile strength, as well as excellent water permeability. Specifically, since the polymer layers are formed on both sides of the mesh and then calcined through the phase transition process, the membrane is not deformed and the fouling phenomenon does not occur even when applying sound waves for thousands of hours.

<PVDF Composite Separation Membrane>

Another aspect of the present invention relates to a PVDF composite separation membrane manufactured by the above-described method of manufacturing a PVDF composite separation membrane.

In short, the present invention relates to a PVDF composite separation membrane prepared by the method of manufacturing a PVDF composite separation membrane, which includes: mixing 0.1 to 10 wt. parts of at least one carbon structure selected from the group consisting of oxidized graphene including a carboxyl group or a hydroxyl group, reduced graphene and carbon nanotubes, with 0.1 to 12 wt. parts of titanium oxide in 73 to 88 wt. parts of a solvent, and dispersing the mixture with ultrasonic waves to obtain a first solution; mixing 1 to 18 wt. parts of a first pore regulator including polyethylene glycol (PEG) having a molecular weight of 190 to 610, and 1 to 22 wt. parts of a second pore regulator including polyvinylpyrrolidone (PVP) having a weight average molecular weight of 8,000 to 900,000 with the first solution, and stirring the mixture at a temperature of 70 to 90° C. to obtain a second solution; mixing 21 to 38 wt. parts of a polyvinylidene fluoride (PVDF) polymer with the second solution and stirring the mixture at a temperature of 70 to 90° C. to obtain a third solution; forming a film from the third solution on a surface of a mesh having a pore size of 25 to 400 μm opposite to one surface provided with a release paper, followed by casting so as to have a thickness of 20 to 600 μm to obtain a primary film forming composite separation membrane; causing a primary phase transition of the primary film forming composite separation membrane in alcohol; causing a secondary phase transition of the primary phase-transited primary film forming composite separation membrane in distilled water; removing the release paper, and then washing the primary film forming composite separation membrane; drying the washed primary film forming composite separation membrane at a temperature of 80 to 120° C.; calcining the dried primary film forming composite separation membrane in an atmospheric furnace at a temperature of 180 to 220° C. to melt and bond the PVDF of the primary film forming composite separation membrane with the mesh, followed by cooling; forming a film from the third solution on the one surface of the mesh from which the release paper of the cooled primary film forming composite separation membrane is removed, followed by casting so as to have a thickness of 20 to 600 μm to obtain a secondary film forming composite separation membrane; causing a primary phase transition of the secondary film forming composite separation membrane in alcohol; causing a secondary phase transition of the primary phase-transited secondary film forming composite separation membrane in distilled water; washing the secondary film forming composite separation membrane; drying the washed secondary film forming composite separation membrane at a temperature of 80 to 120° C.; and calcining the dried secondary film forming composite separation membrane in an atmospheric furnace at a temperature of 230 to 290° C. to melt and bond the PVDF of the secondary film forming composite separation membrane with the mesh, followed by cooling.

Since the PVDF is excellent in terms of heat resistance and workability, thus to be widely used in the art, but the PVDF membranes using the same have a problem in that they are generally vulnerable to natural organic materials. However, since the PVDF membrane according to the present invention is manufactured by the above-described method of manufacturing a PVDF composite separation membrane, there is an advantage in that mechanical strength may be maximized and excellent durability may be maintained.

The PVDF composite separation membrane according to the present invention undergoes the calcining step thus to achieve melt bonding between the polymers of the composite separation membrane, and thereby having advantages of excellent durability even under high pressure as well as ultrasonic waves. Specifically, the melt bonding may be melt crosslinking.

In the case of PVDF composite separation membrane according to another embodiment of the present invention, the PVDF composite separation membrane may be a porous membrane including pores having an average pore size of 0.05 μm to 20 μm. The PVDF composite separation membrane is based on the nonsolvent-induced phase transition process and the calcination process, and specifically, the PVDF composite separation membrane may be a membrane including multi pores having a size of 0.05 μm to 20 μm, in which the PVDF polymer, graphene and/or carbon nanotubes, and titanium oxide are complexly bonded with the mesh.

Preferably, the PVDF composite separation membrane may be a porous membrane including pores having an average pore size capable of being controlled to various pore sizes such as 0.05 μm to 0.1 μm, 0.1 μm to 0.5 μm, 0.5 μm to 1 μm, 1 μm to 3 μm, 3 μm to 5 μm, 5 μm to 10 μm, 10 μm to 15 μm, 15 μm to 20 μm and the like. In addition, preferably, the PVDF composite separation membrane is a porous membrane in which the average pore size of the polymer layer of the primary film forming composite separation membrane may be controlled to 5 μm to 20 μm, and the average pore size of the polymer layer of the secondary film forming composite separation membrane may be controlled to 0.05 μm to 20 μm.

When the PVDF composite separation membrane includes the polymer layers formed on both sides thereof such that each membrane has pores satisfying the above-described average pore size, damage to the separation membrane may be minimized even in a poor water treatment environment. In addition, by differently forming the sizes of pores on both sides of the PVDF composite separation membrane depending on the properties of inflowing fluid, the membrane may have excellent water permeability and durability. For example, if a separation membrane including pores having an average pore size of 10 μm is required depending on the properties of the inflowing fluid, the pore size of the PVDF composite separation membrane may be controlled so that the pores on one surface have an average pore size of 10 μm, and the pores on the other surface have an average pore size of 20 μm. When the PVDF composite separation membrane has pores satisfying the above-described average pore size, the membrane may have high water permeability, thus being preferable.

In another embodiment of the present invention, the PVDF composite separation membrane may have a tensile strength of 130 MPa or more, specifically 130 to 150 MPa, and more specifically 140 to 150 MPa.

In another embodiment of the present invention, the PVDF composite separation membrane may have a water permeability of 72,300 L/m²hr or more, and specifically 72,300 to 950,000 L/m²hr.

The PVDF composite separation membrane according to the present invention includes graphene and PVDF, thereby having advantages of excellent mechanical strength as well as excellent chemical resistance. Thereby, the biofouling phenomenon is suppressed, the membrane is not eroded even by high-output ultrasonic waves, and damage to the membrane is suppressed even when applying a high pressure thereto. Therefore, the inventive membrane may be applied to various water treatment and air treatment for each size of the pores, such as drinking water, sewage, industrial wastewater, seawater and the like. In particular, when the PVDF composite separation membrane according to the present invention is applied as a crossflow filter, effectiveness thereof is excellent.

Hereinafter, examples will be described to more concretely understand the present invention. However, it will be apparent to those skilled in the art that various modifications and alterations of such examples of the present disclosure may be possible as defined by the appended claims, and the scope of the present invention is duly not limited to the following examples. Such examples of the present disclosure are provided for completely describing the present invention to persons having ordinary knowledge and skills in the related art. In addition, “%” and “part” indicating the content below are based on weight unless the context specifically indicates otherwise.

### Example 1

Preparation of Primary Film Forming Solution

0.1 wt. parts of reduced graphene oxide (rGO) including a carboxyl group (Smart Nano Co., Ltd.) and 0.1 wt. parts of titanium oxide were mixed in 78 wt. parts of DMAC, then the mixture was dispersed with ultrasonic waves for 3 hours to obtain a first solution for primary film forming.

1 wt. part of PEG 200 (Samjeon) and 0.5 wt. parts of PVP K30 (ACROS) having a weight average molecular weight of 50,000 were mixed with the first solution, then the mixture was dispersed at a temperature of 80° C. for 1 hour to obtain a second solution for primary film forming.

26 wt. parts of PVDF (SOLVAY 6020) having a weight average molecular weight of 700,000 was mixed with the second solution, then the mixture was stirred and dissolved at a temperature of 80° C. for 6 hours, followed by removing air bubbles to obtain a third solution for primary film forming.

Preparation of Secondary Film Forming Solution

1.5 wt. parts of reduced graphene oxide (rGO) including a carboxyl group and 1 wt. part of titanium oxide were mixed with 83 wt. parts of DMAC, then the mixture was dispersed with ultrasonic waves for 3 hours to obtain a first solution for secondary film forming.

12 wt. parts of PEG 200 and 7 wt. parts of PVP K30 were mixed with the first solution, then the mixture was dispersed at a temperature of 80° C. for 3 hours to obtain a second solution for secondary film forming.

30 wt. parts of PVDF having a weight average molecular weight of 700,000 was mixed with the second solution, then the mixture was stirred and dissolved at a temperature of 80° C. for 6 hours to obtain a third solution for secondary film forming.

Preparation of PVDF Composite Separation Membrane

After attaching a release paper to a lower portion of a metal mesh having a pore size of 40 μm and a thickness of 60 μm to prevent the solution from being discharged to a lower portion, the mesh was placed on a glass plate to be into closely contact therewith, and the third solution for primary film forming was cast on an upper portion of the metal mesh so as to have a film forming thickness of 400 μm. Thereafter, a composite separation membrane was obtained by causing a primary phase transition in 99.5% ethanol for 60 minutes, and causing a secondary phase transition in distilled water for 30 minutes, and then the release paper was removed from the metal mesh. Subsequently, the obtained composite separation membrane was washed with distilled water, dried in an oven at 80° C. for 1 hour, and calcined in an atmospheric furnace at a temperature of 220° C. to melt and bond polymers of the composite separation membrane, followed by cooling to a temperature of 100° C. or lower, thus to prepare a primary film forming composite separation membrane including pores having an average pore size of 20 μm.

Then, after casting from the third solution for secondary film formation on the lower portion of the mesh from which the release paper is removed so as to have a film thickness of 60 μm, a composite separation membrane was obtained by causing a primary phase transition in ethanol for 60 minutes, and causing a secondary phase transition in distilled water for 30 minutes. Thereafter, the obtained composite separation membrane was washed with distilled water, dried in an oven at 80° C. for 1 hour, and calcined in an atmospheric furnace at a temperature of 260° C. to melt and bond polymers of the composite separation membrane, followed by cooling to a temperature of 100° C. or lower, thus to manufacture a PVDF composite separation membrane including pores having an average pore size of 0.5 μm.

### Example 2

A PVDF composite separation membrane including pores having an average pore size of 0.5 μm was manufactured according to the same procedures as described in Example 1, except that a metal mesh having a pore size of 60 μm and a thickness of 80 μm was applied thereto.

### Comparative Example 1

After attaching a release paper to a lower portion of a metal mesh having a pore size of 40 μm and a thickness of 60 μm to prevent the solution from being discharged to a lower portion, the mesh was placed on a glass plate to be into closely contact therewith, and the same third solution for primary film forming as in Example 1 was cast on an upper portion of the metal mesh so as to have a film forming thickness of 400 μm. Thereafter, a composite separation membrane was obtained by causing a primary phase transition in 99.5% ethanol for 60 minutes, and causing a secondary phase transition in distilled water for 30 minutes, and then the release paper was removed from the metal mesh. Subsequently, the obtained composite separation membrane was washed with distilled water, dried in an oven at 80° C. for 1 hour, and calcined in an atmospheric furnace at a temperature of 260° C. to melt and bond polymers of the composite separation membrane, followed by cooling to a temperature of 100° C. or lower, thus to manufacture a PVDF composite separation membrane including pores having an average pore size of 20 μm.

### Comparative Example 2

A PVDF composite separation membrane including pores having an average pore size of 0.5 μm was manufactured according to the same procedures as described in Comparative Example 1, except that a metal mesh having a pore size of 60 μm and a thickness of 80 μm was applied thereto.

### Comparative Example 3

A composite separation membrane including pores having an average pore size of 0.5 μm was manufactured according to the same procedures as described in Example 1, except that the calcination step did not undergo.

### Comparative Example 4

A composite separation membrane including pores having an average pore size of 0.5 μm was manufactured according to the same procedures as described in Example 2, except that the calcination step did not undergo.

### Comparative Example 5

A composite separation membrane was manufactured using only a metal mesh having a pore size of 40 μm and a thickness of 60 μm thickness, on which film forming was not performed, and used.

### Comparative Example 6

A composite separation membrane was manufactured using only a metal mesh having a pore size of 60 μm and a thickness of 80 μm thickness, on which film forming was not performed, and used.

### Comparative Example 7

0.5 μm Glass Microfiber Filter for particle and turbidity analysis manufactured by GE was used.

### Comparative Example 8

A flat membrane of 0.2 to 0.3 μm made of CPVC by PicoMB Tech commercially available in Korea was used.

### Experimental Example 1

Tensile strengths of the separation membranes manufactured according to the examples, and Comparative Examples 1 to 4 were measured, and results thereof are shown in Table 1 below. The tensile strength was measured using a universal material testing machine (Unstrone 4303) capable of measuring the tensile strength and compressive strength.

TABLE 1

| | | Film forming | Calcination | |
|---|---|---|---|---|
| | | thickness | temperature | |
| | | (Primary film | (Primary film | |
| | Pore size and | forming/secondary | forming/secondary | Tensile |
| Section | thickness of mesh | film forming) | film forming) | strength |
| Example 1 | Pore size 40 μm/ | 400 μm/60 μm | 220° C./260° C. | 155 MPa |
| | thickness 60 μm | | | |
| Example 2 | Pore size 60 μm | 400 μm/60 μm | 220° C./260° C. | 168 MPa |
| | thickness 80 μm | | | |
| Comparative | Pore size 40 μm/ | 400 μm/— | 220° C./— | 130 MPa |
| Example 1 | thickness 60 μm | | | |
| Comparative | Pore size 60 μm/ | 400 μm/— | 220° C./— | 150 MPa |
| Example 2 | thickness 80 μm | | | |
| Comparative | Pore size 40 μm/ | 400 μm/60 μm | — | 109 MPa |
| Example 3 | thickness 60 μm | | | |
| Comparative | Pore size 60 μm/ | 400 μm/60 μm | — | 117 MPa |
| Example 4 | thickness 80 μm | | | |
| Comparative | Pore size 40 μm/ | — | — | 97 MPa |
| Example 5 | thickness 60 μm | | | |
| Comparative | Pore size 60 μm/ | — | — | 111 MPa |
| Example 6 | thickness 80 μm | | | |

As shown in Table 1 above, in the case of Comparative Examples 1 and 2 in which the polymer layer was formed on only one surface of the mesh, it can be confirmed that the membranes have lower tensile strengths than Examples 1 and 2 in which the polymer layers are formed on both sides of the mesh, and in the case of Comparative Examples 3 and 4 in which the calcination was not performed after phase transition, it can be seen that the membranes have very low tensile strengths. From this results, in the case of the PVDF composite separation membrane according to the present invention, it is expected that the breakage phenomenon of the membrane due to the pressure will be significantly reduced.

### Experimental Example 2

Turbidities of the PVDF composite separation membrane manufactured according to the examples were comparatively analyzed using a standard experimental filter for 0.5 μm particle analysis and turbidity analysis (Comparative Example 7), and the results thereof are shown in Table 2 below.

TABLE 2

| | Turbidity (sample |
|---|---|
| Section | turbidity 13 NTU) |
| Example 1 | 1.05 NTU |
| Example 2 | 1.06 NTU |
| Comparative Example 7 | 1.2 NTU |

As shown in Table 2 above, it can be seen that the PVDF composite separation membranes according to the present invention are excellent in terms of experimental results of the turbidity.

### Experimental Example 3

Water permeabilities of the PVDF composite separation membranes prepared according to the examples and the Comparative Example 8 were analyzed, and results thereof are shown in Table 3 below.

The water permeabilities of the separation membranes of Examples 1 and 2 and Comparative Example 8 were measured using ultrapure water (measured pressure: 1 kgf/cm²), and average pore sizes thereof were measured using a PMI Bubble Point Tester.

TABLE 3

| | Water permeability |
|---|---|
| Section | (LMH, L/m²hr) |
| Example 1 | 72,300 LMH |
| Example 2 | 76,100 LMH |
| Comparative Example 8 | 5,500 LMH |

As shown in Table 3 above, it can be seen that the PVDF composite separation membranes according to the present invention are excellent in terms of water permeability.

### Experimental Example 4

The separation membranes manufactured according to Example 1 and Comparative Example 1 were attached to a housing of a cross-flow type filter, then the filter was inserted and installed in an ultrasonic device, and a pressure of 0.5 to 2 bar was applied thereto using a butterfly valve while supplying a solution with 34 NTU of 50 ppm turbidity, while continuously operating ultrasonic waves of 28 KHz to check whether the separation membranes are deformed every 24 hours for 120 days. Results thereof are shown in Table 4 below.

TABLE 4

| Section | Check time | Whether transformed |
|---|---|---|
| Example 1 | Up to 2880 hr | No transformation |
| Comparative Example 1 | Up to 596 hr | Detachment and |
| | | membrane breakage |

As shown in Table 4 above, it can be seen that the PVDF composite separation membrane according to the present invention has the polymer layers formed on both sides of the mesh, such that the durability is significantly improved compared to the composite separation membrane of Comparative Example 1 having the polymer layer formed on only one surface of the mesh.

1: A method of manufacturing a polyvinylidene fluoride (PVDF) composite separation membrane, the method comprising:
mixing 0.1 to 10 parts by weight of at least one carbon structure selected from the group consisting of oxidized graphene including a carboxyl group or a hydroxyl group, reduced graphene and carbon nanotubes, with 0.1 to 12 parts by weight of titanium oxide in 65 to 95 parts by weight of a solvent, and dispersing the mixture with ultrasonic waves to obtain a first solution;
mixing 1 to 18 parts by weight of a first pore regulator including polyethylene glycol (PEG) having a molecular weight of 190 to 610, and 1 to 22 parts by weight of a second pore regulator including polyvinylpyrrolidone (PVP) having a weight average molecular weight of 8,000 to 900,000 with the first solution, and stirring the mixture at a temperature of 70 to 90° C. to obtain a second solution;
mixing 21 to 38 parts by weight of a polyvinylidene fluoride (PVDF) polymer with the second solution and stirring the mixture at a temperature of 70 to 90° C. to obtain a third solution;
forming a film from the third solution on a surface of a mesh having a pore size of 25 to 400 μm opposite to one surface provided with a release paper, followed by casting so as to have a thickness of 20 to 600 μm to obtain a primary film forming composite separation membrane;
causing a primary phase transition of the primary film forming composite separation membrane in alcohol;
causing a secondary phase transition of the primary phase-transited primary film forming composite separation membrane in distilled water;
removing the release paper, and then washing the primary film forming composite separation membrane;
drying the washed primary film forming composite separation membrane at a temperature of 80 to 120° C.;
calcining the dried primary film forming composite separation membrane in an atmospheric furnace at a temperature of 180 to 220° C. to melt and bond the PVDF of the primary film forming composite separation membrane with the mesh, followed by cooling;
forming a film from the third solution on the one surface of the mesh from which the release paper of the cooled primary film forming composite separation membrane is removed, followed by casting so as to have a thickness of 20 to 600 μm to obtain a secondary film forming composite separation membrane;
causing a primary phase transition of the secondary film forming composite separation membrane in alcohol;
causing a secondary phase transition of the primary phase-transited secondary film forming composite separation membrane in distilled water;
washing the secondary film forming composite separation membrane;
drying the washed secondary film forming composite separation membrane at a temperature of 80 to 120° C.; and
calcining the dried secondary film forming composite separation membrane in an atmospheric furnace at a temperature of 230 to 290° C. to melt and bond the PVDF of the secondary film forming composite separation membrane with the mesh, followed by cooling.

2: The method of claim 1, wherein the mesh has a pore size of 25 μm to 400 μm.

3: The method of claim 1, wherein the mesh has a thickness of 40 μm to 600 μm.

4: The method of claim 1, wherein the third solution further comprises at least one selected is from the group consisting of polysulfone (PSF), polyethersulfone (PES), polyethylene (PE), polypropylene (PP), polycarbonate (PC) and polyethylene terephthalate (PET).

5: A double-sided PVDF composite separation membrane manufactured by the method of manufacturing a PVDF composite separation membrane according to claim 1.

6: The double-sided PVDF composite separation membrane according to claim 5, wherein the double-sided PVDF composite separation membrane is a porous membrane including pores having an average pore size of 0.05 μm to 20 μm.

7: The double-sided PVDF composite separation membrane according to claim 5, wherein the double-sided PVDF composite separation membrane has a tensile strength of 120 MPa or more.

8: The double-sided PVDF composite separation membrane according to claim 5, wherein the double-sided PVDF composite separation membrane has a water permeability of 72,300 L/m²hr or more.
